(19) United States
(12) Patent Application Publication
(10) Pub. No.: US 2014/0011479 A1
(43) Pub. Date: Jan. 9, 2014

(54) IDENTIFICATION METHOD FOR ACCESSING MOBILE BROADBAND SERVICES OR APPLICATIONS

(71) Applicants: Javier Garcia Puga, Madrid (ES); Javier Martinez Alvarez, Madrid (ES); Roberto Perez Cubero, Madrid (ES)

(72) Inventors: Javier Garcia Puga, Madrid (ES); Javier Martinez Alvarez, Madrid (ES); Roberto Perez Cubero, Madrid (ES)

(73) Assignee: TELEFONICA S.A., Madrid (ES)

(21) Appl. No.: 13/979,095

(22) PCT Filed: Dec. 26, 2011
(86) PCT No.: PCT/EP11/74058

§ 371 Date: Sep. 26, 2013

(30) Foreign Application Priority Data
Jan. 11, 2011 (ES) P201130019

(51) Int. Cl. H04W 12/06

(52) U.S. Cl. CPC H04W 12/06
USPC 455/411

(57) ABSTRACT

An identification method for accessing mobile Broadband services or applications using a communications device of a computing equipment and involving sending a credential to a server providing Broadband services or applications, through an MBB network.

### FIELD OF THE ART

The present invention generally relates to an identification method for accessing MBB services or applications, by using credentials associated to a requested service or application, and more particularly to a method comprising using a communications device, such as a USB dongle, for collaborating in the encryption/decryption of said credentials to increase the security associated to their access.

### PRIOR STATE OF THE ART

Generally, authorization and identity methods in web services and applications are performed by the manual introduction of a set of credentials, typically a user and password. Since every service has different policies for setting up these credentials, i.e. number of characters, usage of symbols or alphanumeric characters, etc., the user is forced to entering different values for each one of these services.

There are some initiatives like OpenID which try to resolve this problem, but the system doesn't reach a relevant number of web services and once again, the user has to remember a new set of user/password.

Another approach for avoiding that users forgetting about the different credentials that they have configured for the different services are the local or network-based “key chains”, such as 1-Password. This kind of services just allows the user to store the different set of credential under a password protected secure repository. So once they enter the repository password they can find all the different set of credentials that they have stored previously. Therefore this kind of initiatives doesn't avoid the need to generate the account manually by the users, just help them to remember it in the future.

Some other web services like the telco operator's related ones leverage on the network credentials. For instance, typically the MSISDN is used as a login, and the password is generated randomly and sent to the user via SMS.

As an overview of the current methods depicted above, we can conclude that all of them require that the user remembers the credential and the necessity of entering it manually when he wants to get access to the service.

The following documents and proposal are related to the present invention, however they address different problems, and the technical solutions to resolve them are different from the one proposed in this document.

The invention proposed in [1] is focused on the device itself rather than specifying the authentication mechanism. Moreover, it doesn't specify the procedure in the first-use activation method and it doesn't specify the way the credentials are stored and if it is using any encryption method to ensure the privacy and security.

It can be observed that invention [2] is about network credentials instead of the credentials to use value-added services. Using the solution proposed in this invention you can leverage the problem when you are moving between different network connectivity environments, but nothing it is said about the credentials of the services you are using within those network environments.

In the invention [3] the identification device does not have any communication feature, it relies on the host device to provide it with the connectivity feature. Moreover, it does not have any ciphering capabilities, and it doesn't specify the credentials storage mechanism. In contrast of the present proposal, the device of this invention acts as a proxy, it intercepts all the network requests, and in case it is need it, it modifies the request in order to add the credentials. In the present invention it is not proposed any kind of proxy as the system doesn't modify the user network requests.

In patent [4] the requests for credential information from a SIM are initiated using EAPSIM. It covers mainly a method to authorize a computer system to connect to a WLAN. Therefore this patent depicts a network authorization method, not a services level one. The same feature is observed in [5]. The system leverages on an external SIM card in order to gain access to a WWAN network. Therefore, once again, this invention only covers the network level but not the services level.

Proposal [6] is based on the implementation on smartcards of procedures of the EAP type, designed to authenticate the user identity in registration phase to the access network through the exchange of keys. So this is not an authentication procedure at the level of service, but registration at the access network by authenticating securely the user. We can extend this conclusion also to [7].

Proposal [8] is oriented to the access during the connection or registration of a terminal in the WLAN network. It introduces a procedure for verifying the identity of the user accessing a connection via a WiFi-GSM dual terminal. This is achieved by generating a user key from the network, associated to the mobile number, which is sent by SMS to it. This key is then used to access the service via WiFi, thus verifying the identity of the user.

The system described in [9] is oriented to the usage of the IMSI identifier in the network access through a mobileIP element, so this is not an authentication level of service, but at a network level to provide access to the terminals. We can extend this conclusion also to [10].

Nowadays, a relevant set of applications and services which are offered to users require that a set of credentials are entered in order to gain access to them. In the case of the users who are accessing to these applications from a mobile broadband network (mobile or USB dongle), the identification is carried out independently from the login credentials of the device in the access network. Thus the user is forced to perform various authentication processes in a sequential manner which normally constitutes a problem, especially because the user has to deal with a new set of credentials and then have to remember them. FIG. 1 illustrates the different elements involved in said authentication processes.

### DESCRIPTION OF THE INVENTION

It is necessary to offer an alternative to the state of the art which covers the gaps found therein.

With that purpose, the present invention provides an identification method for accessing mobile Broadband (MBB) services or applications, comprising, by means of a communications device (such as a USB dongle) of a computing equipment, sending at least one credential to a server providing said Broadband services or applications, through a mobile broadband, or MBB, network, in order to get identified to have access to a user requested service or application, out of said services or applications.

On contrary to known proposals, the method of the invention comprises performing automatically the next actions:

obtaining a certificate from a SIM card of said communications device;

encrypting said at least one credential by means of an encryption algorithm, using said certificate as an input to said encryption algorithm;

storing the at least one encrypted credential into a memory of the communications device; and

performing said sending of the at least one credential, in clear, before and/or after said encryption.

For an embodiment of the method for which the encrypted credential is already stored in said memory, the method comprises:

retrieving, from said memory, the encrypted credential stored therein;

obtaining said certificate from said SIM card of the communications device;

decrypting the encrypted credential by means of an encryption algorithm, using said certificate as an input to said encryption algorithm; and

performing said sending of the credential, in clear, once decrypted.

Other embodiments of the method of the invention are described in the appended claims and in a posterior section of the present description.

### BRIEF DESCRIPTION OF THE DRAWINGS

The previous and other advantages and features will be more fully understood from the following detailed description of embodiments, with reference to the attached drawings (some of which have already been described in the Prior State of the Art section), which must be considered in an illustrative and non-limiting manner, in which:

FIG. 1 shows a conventional architecture requiring the need of performing an authentication process in order to access to an application or service.

FIG. 2 shows the different elements used by the method of the invention, for an embodiment.

FIG. 3 shows a complete credentials retrieval flow diagram with different alternatives, for an embodiment of the method of the invention.

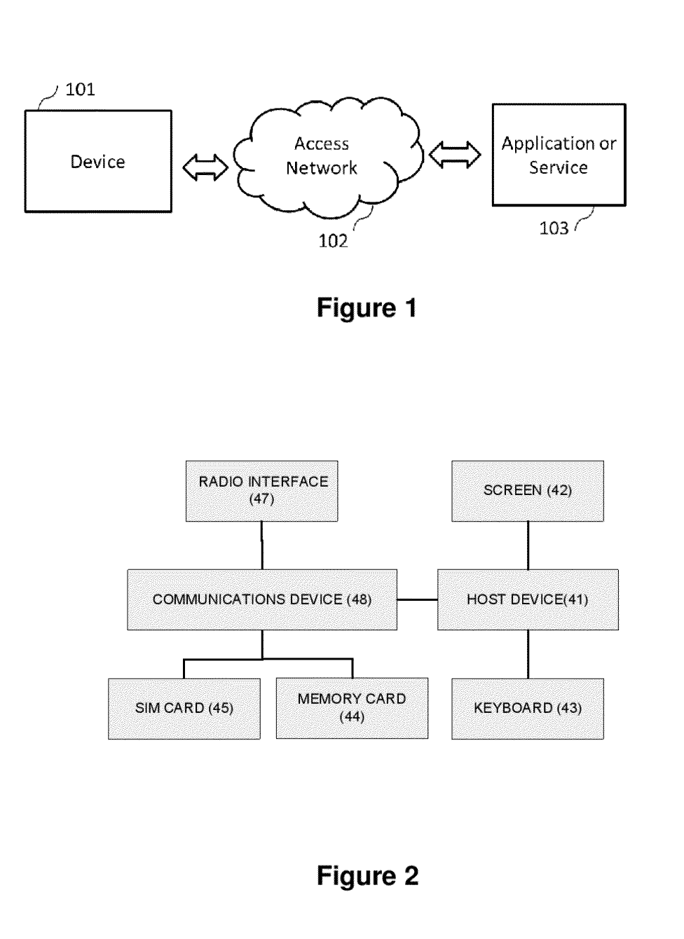

### DETAILED DESCRIPTION OF SEVERAL EMBODIMENTS

The invention provides a simple method to identify a user to access to services or applications, by leveraging in the user authentication provided by the telco operators, by means of MBB connections or SMS/USSD messages and in the cryptographic functionalities provided by SIM card, which is inserted in the device, such as a mobile broadband USB dongle.

Using the mechanism of the method of the invention, the user is logged in the service transparently and “silently”, so the user doesn't need to remember and enter the service credentials each time he uses the MBB dongle.

In contrast with other solutions, the present invention is focused in a service level authentication, instead of network level authentication, therefore, the activation process and the credentials stored in our invention are the credentials of the given service or application.

Another strong point of this invention is the use of the SIM card and the GSM connection certificate to encrypt the service credentials. This certificate is usually used to connect to the GSM network but not to cipher content in the client side. In combination with the SIM card inside the mobile broadband dongle, we can use and store the user credentials in a secure way. The users will only need to know the SIM card PIN code in order to gain access to these services or applications.

The main idea of this proposal is to take advantage of the access network identification (generally IMSI or MSISDN) when getting access to these services of applications. Therefore, the USB dongle is turned into the access key for this kind of services or applications, by doing this in a new and innovative way, which is protecting “the key” by the SIM PIN private code.

By storing the credentials encrypted using the GSM certificate stored in the SIM card of the device, third parties cannot recover them without knowing the PIN code of the SIM. This is why the credentials are fully protected against unauthorized use. As the service is protected by these credentials, the service access is closed against users who do not know the PIN of the SIM card.

As the credentials are managed by a single authentication and activation service server, it is possible to centralize the management of all the activation and authentication requests needed to operate the service.

As shown in FIG. 2 the host device 41, referred in a previous section as computing device, where the communication device 48 (typically a USB dongle) is installed, is running the software trying to access a service on behalf of the user. That device (typically a computer) is composed of, among other elements, a controller to handle the communication with the communications device, a screen 42 and a keyboard 43.

The communications device has a sim card 45 and a memory card 44, an I/O interface and a radio interface 47 to allow the host device 41 to access to the network where the service is hosted.

The authentication has several flows in function of the state of credentials:

1. When a user wants to access a service, the device goes to the memory card 44 to look up the credentials of the current service, if it doesn't exist, the device 48 automatically, or the user, will send a request via HTTP (connected through a MBB connection) or SMS or USSD message using the radio interface 47 to ask the activation server for a credential for the concrete user and the concrete service.

2. The activation server validates the user based on the mobile network identity (generally IMSI or MSISDN) and sends back a new message containing the credentials to access the requested service.

3. The device goes to the SIM card 45 to get a certificate; the procedure used is execute in the SIM the standard function “Run GSM Algorithm” passing a fixed seed as argument, if the SIM is locked then a message is shown on the screen to allow the users to introduce the pin. The user introduces the key using the keyboard 43, if the key entered is valid a certificate is generated. If the SIM isn't locked, the pin isn't necessary. This certificate is unique by SIM, each SIM has its own certificate and another SIM has a different certificate.

4. Once the certificate is obtained, the next step is to use it as an input into a symmetric encryption algorithm to encrypt it with the credentials obtained in step 2.

5. The encrypted credential is saved in the memory card of the system.

6. The credential obtained in step 2 is used, in clear, to access the service.

If the user later wants to access the service, the steps would be as follows because the credentials are already stored on the memory card:

7. The device goes to the memory card (44) to look up the encrypted credentials for the current service that the user saved previously

8. The device goes to the SIM card (45) to get a certificate; the procedure consists in executing in the SIM the standard function “Run GSM Algorithm” passing a fixed seed as argument, so if the SIM is locked then a message is shown on the screen to allow the user to introduce the pin. The user introduces the key using the keyboard (43) and if the key entered is valid a certificate is generated. If the SIM is not locked, the pin is not necessary.

9. Once the certificate is obtained, the next step is to use an input into a symmetric encryption algorithm to decrypt it with the credentials obtained in step 7.

10. The credential decrypted in the previous step is used to access the service.

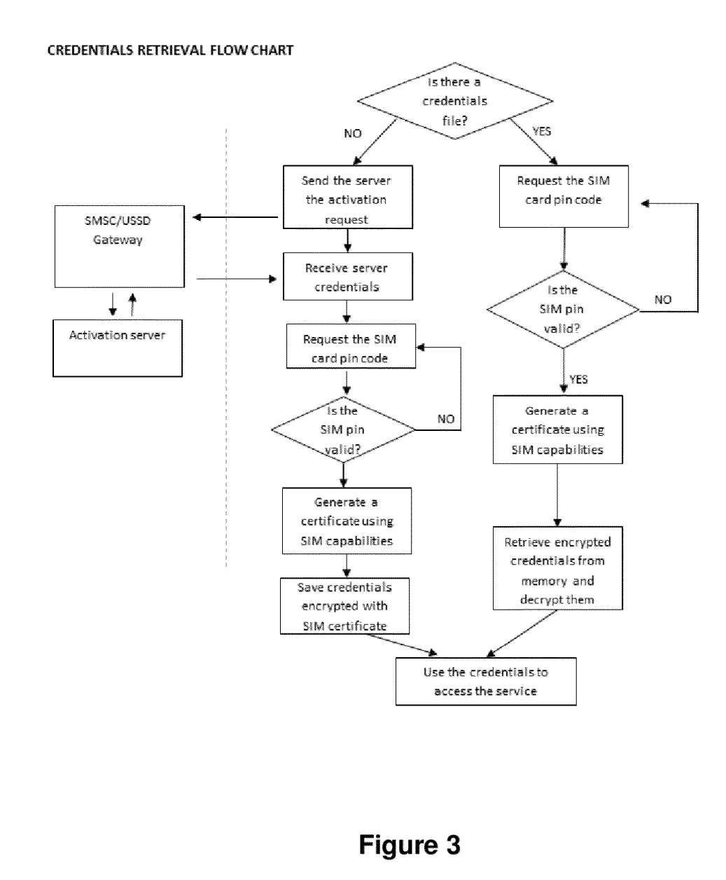

FIG. 3 shows the diagram with the complete flow with the different alternatives stated above, which will be perform depending on the response to the question “Is there a credentials file?” indicated at the disjunctive box at the top of the flow chart: if the answer is NO the actions of the left branch of the flow chart will be performed, which are the ones indicated above as 1 to 6; and if the answer is YES the right branch actions will be performed, which correspond to the above indicated as 7 to 10.

For an embodiment of the method of the invention, the next elements are involved:

1. A procedure for sending the validation request form without the requirement of the active intervention of the user and based on the mobile broadband network. The request is sent transparently from the user's perspective; therefore there is no requirement to the user to start the process. Then the necessary credentials to use the given service are obtained.

2. A server which is responsible for redirecting the broadband network incoming requests (through SMS or USSD) to the web service deployed on the backend server. This server will receive requests from the customers' MBB dongles, then it will make the activation request needed to activate the user account to the backend server. After getting the credentials, the server will send them back to the client device. Communication between the server and the backend which hosts the web service will take place using Secure Internet protocols like HTTP over Secure Socket Layer or HTTPS.

3. A procedure for delivering encrypted credentials from the backend server to the client. Once the activation and generation of the credentials are done, they will be sent back to the client using the same channel that the request was received. First from the backend server through the server using HTTP/HTTPS and lastly to the customer's device using a network mechanism such as SMS or USSD

4. A procedure of secure storage of the credentials in the internal memory or removable USB dongle MBB. This procedure relies on the GSM certifications algorithms provided by the SIM which are contained in the MBB dongle. Once the credentials are received from the authentication and validation server, the system stores them securely in the device memory, so that they can be re-used on several occasions, thus providing per-user user security. Any person who doesn't know the PIN code of the SIM card won't be able to read and use the credentials.

A person skilled in the art could introduce changes and modifications in the embodiments described without departing from the scope of the invention as it is defined in the attached claims.

### ACRONYMS AND ABBREVIATIONS

ADSL Asymmetric Digital Subscriber Line
GSM Global System for Mobile Communications
HTTP Hypertext Transfer Protocol
HTTPS Hypertext Transfer Protocol Secure
IMEI International Mobile Equipment Identity
IMSI International Mobile Subscriber Identity
MBB Mobile Broadband
MSISDN Mobile Subscriber ISDN Number
PIN Personal Identification Number
SIM Subscriber Identity Module
SMS Short Message Service
UMTS Universal Mobile Telecommunication System
USSD Unstructured Supplementary Service Data

### REFERENCES

[1] “Generic Identity Module for Telecommunication Services”, US20090191916A1, Eitan MARDIKS, Raanana (IL).

[2] “Connectivity Manager to Manage Connectivity Services”, WO2009025707A1, COLE, Terry, L (US), TORMO, Jose (US).

[3] “Service access control”, WO20010075885A1, BAUER-HERMANN, Markus (DE), MEYER, Gerand (DE), SEIDL, Robert (DE).

[4] “Enhanced general packet radio service (GPRS) mobility management”, US20040162105A1, RAMGOPAL K. REDDY (US), DHIRAJ BATT (US).

[5] “System including a wireless wide area network (WWAN) module with an external identity module reader and approach for certifying the WWAN module”, US20050288056A1, SUNDEEP M. BAJIKAR (US), FRANCIS X. MCKEEN (US).

[6] 3GPP, 3GPP TSG SA WG3 Security—S3#28 (S3-030198) 6-9 May 2003, Berlin, Germany. “EAP support in smartcards and security requirements in WLAN authentication”.

[7] “SIM-based Subscriber Authentication for Wireless Local Area Networks”, Yuh-Ren Tsai and Cheng-Ju Chang, 2003 IEEE. Proceedings of IEEE 37th Annual 2003 International Carnahan Conference on Security Technology.

[8] “A convenient and secure wireless LAN authentication method and system based on SMS mechanism of GSM”, TW252649B, LEE WEI-BIN (TW); YEH CHANG-KUO (TW).

[9] “Method and system for GSM-authentication during roaming in wireless local networks”, RU2295200, Shtadel Mann Toni (CH); Kauts Mikhel (CH).

[10] “Authentication method e.g. for multimode terminal within wireless network, GSM, GPRS, UMTS, involves authentication of multi-mode terminal in wireless network under use of existing or channel which can be developed to second network”, GRIMMINGER JOCHEN (DE); GROETING WOLFGANG (DE).

1.-5. (canceled)

6. Identification method for accessing mobile Broadband services or applications, comprising, by means of a communications device of a computing equipment, sending at least one credential to a server providing said Broadband services or applications, through a mobile broadband, or MBB, network, in order to get identified to have access to a user requested service or application, out of said services or applications, wherein said at least one credential is encrypted and stored into a memory of the communications device comprising performing automatically the next actions:
obtaining a certificate from a SIM card of said communications device;
encrypting said at least one credential by means of an encryption algorithm, using said certificate as an input to said encryption algorithm;
storing the at least one encrypted credential into a memory of the communications device and
performing said sending of the at least one credential, in clear, before and/or after said encryption.
wherein in order to obtain said at least one credential of said user requested service it performs next actions:
accessing, by said communications device, said memory to look up for said at least one credential of the requested service, after requesting, a user, access to a service by interacting with input means of said computing equipment,
wherein if said at least one credential is not found:
sending, by the communications device automatically or by the user manually, a request, through the MBB network by means of a MBB radio interface of the communications device, to an activation server for said at least one credential;
making, by said activation server, the activation request needed to activate the user account to a backend server, thus obtaining the requested at least one credential therefrom;
sending, by the activation server, the at least one credential for the requested service to the computing equipment, through the MBB network, and
once the at least one credential is received from the activation server, storing them securely in the communication device memory, so that they can be re-used on several occasions, thus providing per-user user security.

7. Identification method as per claim 6, comprising executing a function in the SIM card for obtaining said certificate.

8. Identification method as per claim 7, wherein said function is the standard function “Run GSM Algorithm”, said executing comprising passing a fixed seed as argument in said “Run GSM Algorithm”.

9. Identification method as per claim 8, wherein said encryption algorithm is a symmetric encryption algorithm.

10. Identification method as per claim 6, wherein, if the SIM is locked, the method comprises unlocking it using a corresponding private personal identification number, or PIN, private code, in order to allow said certificate obtaining.
